(19) United States
(12) Patent Application Publication
(10) Pub. No.: US 2017/0266900 A1
(43) Pub. Date: Sep. 21, 2017

(54) MATRIX FOR A TIRE MOLD, TIRE MOLD AND PRODUCTION METHOD

(71) Applicant: Herbert Maschinenbau GmbH & Co. KG, Huenfeld (DE)

(72) Inventor: Martin Grosch, Huenfeld (DE)

(21) Appl. No.: 15/446,112

(22) Filed: Mar. 1, 2017

(30) Foreign Application Priority Data
Mar. 17, 2016 (DE) 10 2016 204 416.8

(51) Int. Cl. B29D 30/06

(52) U.S. Cl. CPC B29D 30/0606; B29D 2030/0617; B29D 2030/0613

(57) ABSTRACT

The invention relates to a matrix (10) for a tire mold, to a tire mold and to a method for producing a tire mold for vulcanizing tire blanks, the matrix forming a negative mold of a profiled tread of a tire, the matrix having a mold shell comprising sipe blades (11) arranged thereon, the mold shell forming an inner mold side (15) and the sipe blade forming a web (19) of the negative mold, a plurality of slots (13) being formed in the mold shell, a sipe blade being inserted in a slot and attached to the mold shell, wherein the sipe blade is attached to the mold shell in a form-fitting manner, the slot penetrating a mold wall (21) of the mold shell and extending from the inner mold side to a rear mold side (16) of the mold shell.

This application claims the benefit of German Patent Application No. 10 201 6 204 416 filed Mar. 17, 2016, the disclosure of which is incorporated by reference.

### TECHNICAL FIELD

The invention relates to a matrix for a tire mold, to a tire mold and to a method for producing a tire mold for vulcanizing tire blanks, the matrix forming a negative mold of a profiled tread of a tire, the matrix having a mold shell comprising sipe blades arranged thereon, the mold shell having an inner mold side and the sipe blade forming a web of the negative mold, a plurality of slots being formed in the mold shell, a sipe blade being inserted in a slot and attached to the mold shell.

### BACKGROUND

Matrices of this kind are well known in the state of the art and serve to line a tire mold used to vulcanize tire blanks. To form a profiled tread of a tire, in particular fine profile grooves of the tread, thin sipe blades are attached to a mold shell of the matrix. Each sipe blade forms a web of the negative mold on an inner mold side of the mold shell. Since the sipe blades are at least thinner than 0.5 mm, they can hardly be produced cost-effectively by machining the mold shell. Hence, it is also known for a plurality of slots to be formed in the mold shell, the sipe blades being attached within said slots. For example, the sipe blades are attached in the respective slots by means of a glue material or by welding them to the material of the mold shell. The substantial aspect is that the sipe blade cannot leave the slot when a vulcanized tire is removed from the tire mold. During vulcanization, a tire blank is placed in the tire mold, the material of the tread being plasticized as a result of temperature influence until the sipe blades can penetrate the material of the tread in such a manner that the negative mold is completely filled and the inner mold side is completely covered by the material of the tread. Since this causes air pockets to form in gaps between sipe blades or profile grooves of the negative mold, the tire mold has to be regularly vented during vulcanization. For this purpose, relatively thin bores through which air can escape are formed in the tire mold or in the inner mold side. The material of the tread will partially enter these bores during vulcanization, as a result of which thread-like material residue from these bores may still be visible on the tread of a fully formed and demolded tire.

The known matrices have the disadvantage that attaching the sipe blades to the mold shell is very complex and replacing potentially worn or damaged sipe blades takes a lot of work. Furthermore, it is disadvantageous that bores for venting have to be provided, which may become clogged and which lead to undesired material residue remaining on the tread.

Thus, the object of the present invention is to provide a matrix for a tire mold, a tire mold, a method for venting a tire mold and a method for producing a tire mold which each allow a more cost-effective production of a tire.

### SUMMARY

The matrix according to the invention for a tire mold for vulcanizing tire blanks forms a negative mold of a profiled tread of a tire, the matrix having a mold shell comprising sipe blades arranged thereon, the mold shell forming an inner mold side and the sipe blade forming a web of the negative mold, a plurality of slots being formed in the mold shell, a sipe blade being inserted in a slot and attached to the mold shell, wherein the sipe blade is attached to the mold shell in a form-fitting manner, the slot penetrating a mold wall of the mold shell and extending from the inner mold side to a rear mold side of the mold shell.

Consequently, each sipe blade is inserted in an associated slot, the slot in the mold shell preferably extending orthogonally in the mold wall, i.e. penetrating the mold wall in the radial direction. The height of the sipe blade is designed in such a manner that the sipe blade forms a web on the inner mold side, said web being able to form a sipe in the tread of the tire and being inserted far enough into the slot for a form-fitting attachment of the sipe blade in the slot to be possible. The fact that the sipe blade is attached to the mold shell in a form-fitting manner allows the sipe blade not only to be easily attached to the mold shell but also to be easily replaced because there is no need for a complex removal of the sipe blade including reworking of the slot in contrast to other connection techniques, such as gluing or welding. Thus, production and maintenance of the matrix is particularly cost-effective. Moreover, venting the tire mold via the slot penetrating the mold wall is possible. Owing to the merely form-fitting attachment of the sipe blade, the slot is not filled with material and sealed like it would be in the case of gluing or welding. Since air can penetrate even very narrow gaps, the solely form-fitting attachment of the sipe blade in the slot opens up the possibility of venting the tire mold via gaps potentially existing between the sipe blade and the slot, which can be within the margins of the common manufacturing tolerances. Hence, it is no longer necessary to form bores for venting in the mold shell, which allows a more cost-effective production of the tire mold and matrix. Also, the usual thread-like material residue on the tread of the tire may be eliminated. Overall, production of the tires becomes more cost-effective.

It is advantageous if a slot width of the slot and a blade thickness of the sipe blade are dimensioned in such a manner that a gap channel can be formed between the sipe blade and the slot. In this case, it becomes possible to vent the tire mold via the gap channel. A width of the gap channel can be particularly thin because a particularly large cross-section of the gap channel for venting can still be realized across a length of the gap channel along the slot. In addition, barely any material of the tread will enter the gap channel during vulcanization if the gap channel is particularly thin, which means that material residue on the tread can be reduced substantially.

The gap channel can have a width of 0.01 mm to 0.1 mm, preferably 0.03 mm to 0.04 mm. A gap channel of such small width has proved sufficient to ensure adequate venting of the tire profile or, more precisely, of a profile section between two sipe blades during vulcanization of a tire blank.

Hence, the gap channel can also be realized as a venting channel for venting the tire mold. Excess air can be drained from the tire mold via other channels existing as needed on the rear mold side of the mold shell.

The sipe blade can also be in contact with the inner mold side at least in sections. For example, the sipe blade can be in contact with the inner mold side at its outer ends with respect to its longitudinal extension. This ensures that the sipe blade is positioned on the mold shell in the desired position relative to the inner mold side. The sipe blade thus forms the web of the negative mold with a defined height and cannot slip deeper into the slot.

A length of the sipe blade, with respect to a longitudinal extension of the sipe blade, can be larger in sections than a length of the slot. Ends of the sipe blade can thus form a stop or projection that can be in contact with the inner mold side.

The sipe blade can be clamped or pre-stressed with zero play between the inner mold side and the rear mold side. If the sipe blade is in contact with the inner mold side, for example, it may be provided for the sipe blade to be form-fittingly fixed to the rear mold side. A form-fit can be realized in such a manner that the sipe blade is fixed with zero play in the radial direction. Depending on the type of fixation or attachment, the sipe blade can additionally be pre-stressed in the area of the sipe blade between the inner mold side and the rear mold side.

Advantageously, the sipe blade can form a projection that is in contact with the rear mold side. Accordingly, the sipe blade can protrude out of the slot at the rear mold side far enough for the projection of the sipe blade to fix the sipe blade in the slot in a form-fitting manner. The projection can be in contact with the rear mold side in such a manner that the sipe blade can no longer be pulled out of the slot in the direction of the inner mold side.

The projection can be formed by bending the sipe blade on the rear mold side, the projection being allowed to protrude out of a slot plane. Since the slot plane inevitably runs through the slot, it becomes possible to prevent the sipe blade from being removed from the slot by means of the projection, which protrudes out of the slot plane. For example, the sipe blade can be inserted into the slot from the inner mold side, the sipe blade then being attached in a form-fitting manner by bending the sipe blade in such a manner that the projection is formed. In this way, complex work for attaching the sipe blade, such as in the case of gluing or welding, is unnecessary. Also, no other attachment means are needed to fix the sipe blade in a form-fitting manner because the fixation solely happens with the sipe blade alone.

The projection can be a flap formed by the sipe blade, wherein the flap can be formed by one or more separating slots in the sipe blade. If the sipe blade is formed by punching, for example, production of the separating slots is particularly simple. In a particularly simple embodiment, the sipe blade alone can have a separating slot, wherein the separating slot can be realized in such a manner that at least one flap is formed on the sipe blade. The flap can be bent relative to the slot in such a manner that the sipe blade cannot be removed from the slot any more. On the other hand, the sipe blade can still be removed from the slot if the flap is bent back to its original position. In this way, particularly simple disassembly of the sipe blade becomes possible.

Advantageously, it may be provided for the flap to be bent about a vertical axis. In the context at hand, a vertical axis means a radial axis with respect to the tire mold.

Alternatively, the flap can be bent about a horizontal axis. In the context at hand, a horizontal axis means an axial axis with respect to the tire mold.

Furthermore, a receiving groove can be realized in the mold shell on the rear mold side, the slot ending in said receiving groove. The receiving groove can be formed deep enough in the rear mold side for the sipe blade to not protrude beyond the receiving groove. Thus, the sipe blade can be attached in a form-fitting manner more easily, for instance in that the flap can be bent only within the receiving groove. An inner wall of the receiving groove can form a stop for the flap. Also, the matrix becomes easier to handle because the sipe blades protruding out of the slots on the rear mold side can no longer be damaged and do not inconveniently protrude during mounting of the matrix on a mold insert.

If the sipe blade is symmetrical, multiple flaps, preferably two, can be realized on the sipe blade, for example, which are bent in opposite directions. Moreover, production of the sipe blade is even easier in this case.

Within the slot, the sipe blade can have a curved or wavelike cross-section with respect to the mold wall at least in sections. In this case, the sipe blade can be clamped within the slot in the manner of a flat spring. This makes a form-fitting attachment by bending the sipe blade even simpler because the sipe blade cannot easily drop out of the slot. Moreover, the formation of a gap channel can be ensured at all times in this case.

The matrix can be composed of a plurality of mold shells. In this case, production of the matrix is more cost-effective because smaller sections of the matrix can be processed in particular in case of complex profile shapes of the tread. Potential mistakes during processing of the matrix or of the mold shell will thus cause lower reject costs.

The tire mold according to the invention for vulcanizing tire blanks has a plurality of tire mold segments, the tire mold segment being formed by a segment base and a mold insert, the mold insert having at least one matrix according to the invention. Thus, large tire mold segments can be easily produced by attaching a plurality of mold inserts to the segment base. In this case, each mold insert can have at least one or more matrices.

In the method according to the invention for venting a tire mold according to the invention, the tire mold is vented via the slot. Regarding the advantages of the method according to the invention, reference is made to the description of advantages of the matrix according to the invention.

Other advantageous embodiments of the method for venting become apparent from the dependent claims referenced back to device claim 1.

In the method according to the invention for producing a tire mold for vulcanizing tire blanks, a matrix forms a negative mold of a profiled tread of a tire, the matrix having a mold shell on which sipe blades are arranged, the mold shell forming an inner mold side and the sipe blade forming a web of the negative mold, a plurality of slots being formed in the mold shell, a sipe blade being inserted into a slot and attached to the mold shell, wherein the sipe blade is attached to the mold shell in a form-fitting manner, the slot penetrating a mold wall of the mold shell and extending from the inner mold side to a rear mold side of the mold shell. Regarding the advantages of the method according to the invention, reference is made to the description of advantages of the matrix according to the invention.

In one embodiment of the method, the form-fitting connection can be formed by deforming the sipe blade on the rear mold side. In this way, mounting of the sipe blades as well as disassembly and replacement become simpler and more cost effective overall.

### BRIEF DESCRIPTION OF THE DRAWINGS

In the following description, preferred embodiments of the invention will be explained in more detail with reference to the accompanying drawing.

In the drawing:

FIG. 1 shows a partial section view of a matrix according to a first embodiment along line I-I of FIG. 4;

FIG. 2 shows a bottom view of the matrix;

FIG. 3 shows a partial section view of the matrix along line III-III of FIG. 4;

FIG. 4 shows a top view of the matrix;

FIG. 5 shows a partial section view of a matrix according to a second embodiment;

FIG. 6 shows a partial section view of a matrix according to a third embodiment;

FIG. 7 shows a partial section view of a matrix according to a fourth embodiment;

FIG. 8 shows a partial view of a sipe blade according to a fifth embodiment;

FIG. 9 shows a partial view of a sipe blade according to a sixth embodiment;

FIG. 10 shows a partial view of a sipe blade according to a seventh embodiment;

FIG. 11 shows a partial view of a sipe blade according to an eighth embodiment;

FIG. 12 shows a partial view of a matrix according to a fifth embodiment; and

FIG. 13 shows a partial section view of a matrix according to a sixth embodiment.

### DETAILED DESCRIPTION

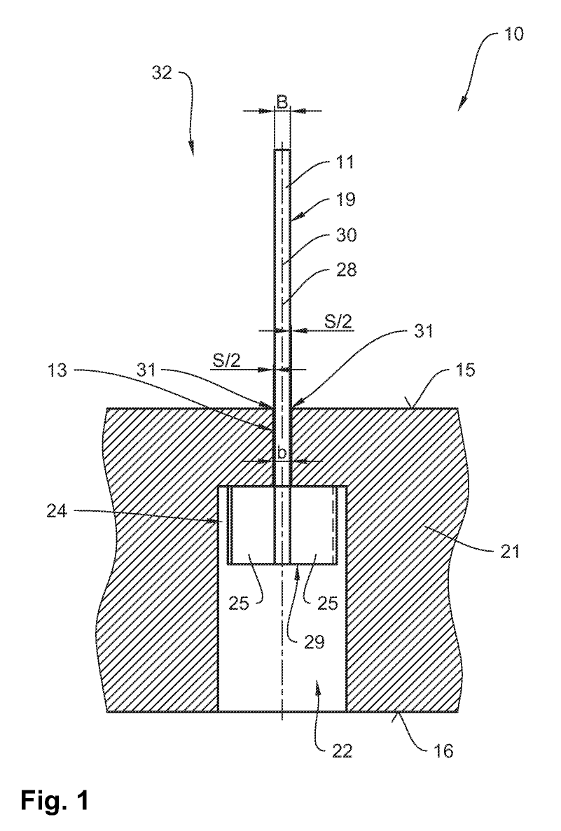

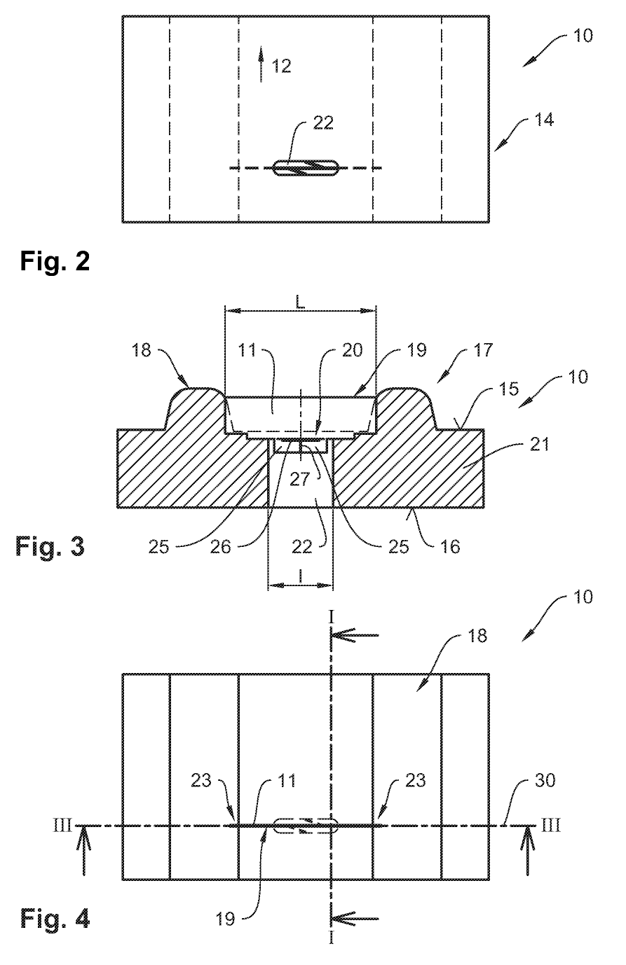

A combined view of FIGS. 1 to 4 shows a schematic illustration of a first embodiment of a matrix 10. The matrix 10 has a plurality of sipe blades 11, of which only one is illustrated here. The sipe blades 11 are arranged in slots 13 and perpendicular to a running direction 12 of a tire to be produced and to a tread thereof. In particular, the slot 13 is formed in a mold shell 14 of the matrix 10, which is illustrated only by way of sections, and extends from an inner mold side 15 of the mold shell 14 to a rear mold side 16 of the mold shell 14. The mold shell 14 can be inserted into a mold insert (not illustrated) of a tire mold and its rear mold side 16 is in contact with the mold insert. The inner mold side 15 forms a negative mold 17 for a tire blank to be vulcanized, profile groove webs 18 being formed on the inner mold side 15. The sipe blade 11, too, forms a web 19 of the negative mold 17.

The slot 13 is formed by a passage opening 20 in a mold wall 21 of the mold shell 14 and ends in a groove 22 on the rear mold side 16. Furthermore, a length L of the sipe blade 11 is larger than a length 1 of the slot 13 so that ends 23 of the sipe blade 11 rest on the inner mold side 15. An appendage 24 of the sipe blade 11 protrudes into the slot 13 and exits the slot 13 again on the rear mold side 16 to enter the groove 22. Here, two flaps 25 that are bent about a vertical axis 28 are formed by separating slots 26 and 27 in such a manner that projections 29 are formed that protrude out of a slot plane 30. Thus, the sipe blade 11 can be mounted particularly easily on the mold shell 14 because it is simply inserted into the slot 13 and the flaps 25 are subsequently bent out of the slot plane 30 so as to attach the sipe blade 11 in a form-fitting manner. The flaps 25 are in particular in contact with the rear mold side 16 so that the sipe blade 11 cannot be pulled out of the slot 13 anymore and is clamped with zero play between the inner mold side 15 and the rear mold side 16.

A blade thickness B of the sipe blade 11 is dimensioned in such a manner that a gap channel 31, which is not visible in detail here, is formed between the sipe blade 11 and the slot 13. The slot 13 is designed with a slot width b>B so that the gap channel 31 has a gap channel width of S=b−B. The gap channel 31 can now be used to vent the tire mold, in particular a profile section 32 adjacent to the sipe blade 11, during vulcanization of tire blanks.

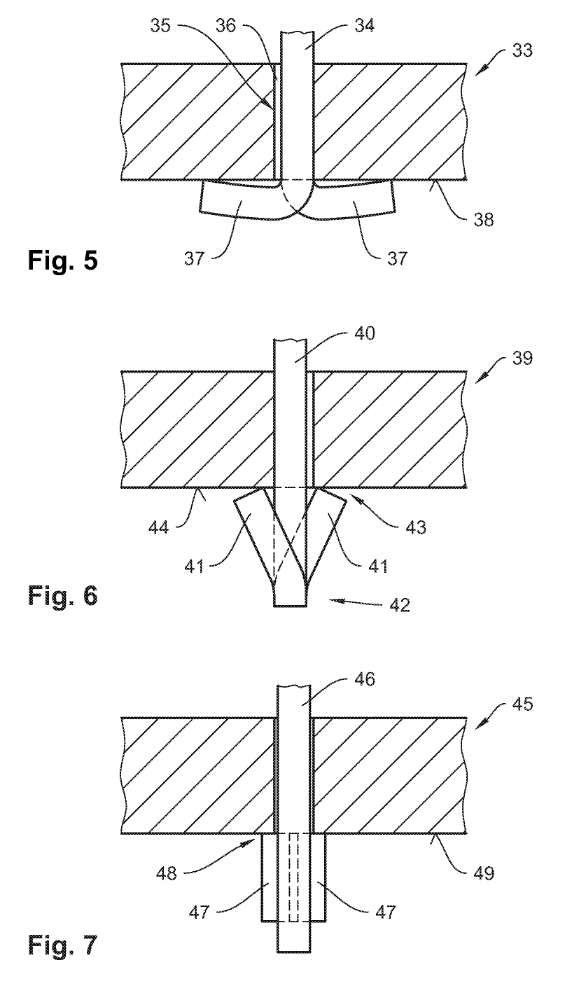

FIG. 5 shows a partial section of a matrix 33 comprising a sipe blade 34, the sipe blade 34 being inserted in a slot 35, thus forming a gap channel 36. Flaps 37 of the sipe blade 34 are each bent by 90° in opposite directions in such a manner that the flaps 37 are in substantially flat contact with a rear mold side 38.

In contrast to FIG. 5, FIG. 6 shows a matrix 39 in which a sipe blade 40 has flaps 41 that are bent in a V-shape at a lower end 42 of the sipe blade 40, upper edges 43 of the flaps 41 thus being in contact with a rear mold side 44.

FIG. 7 shows a matrix having a sipe blade 46 in which flaps 47 are widened in opposite directions by bending in such a manner that their upper edges 48 are in contact with a rear mold side 49.

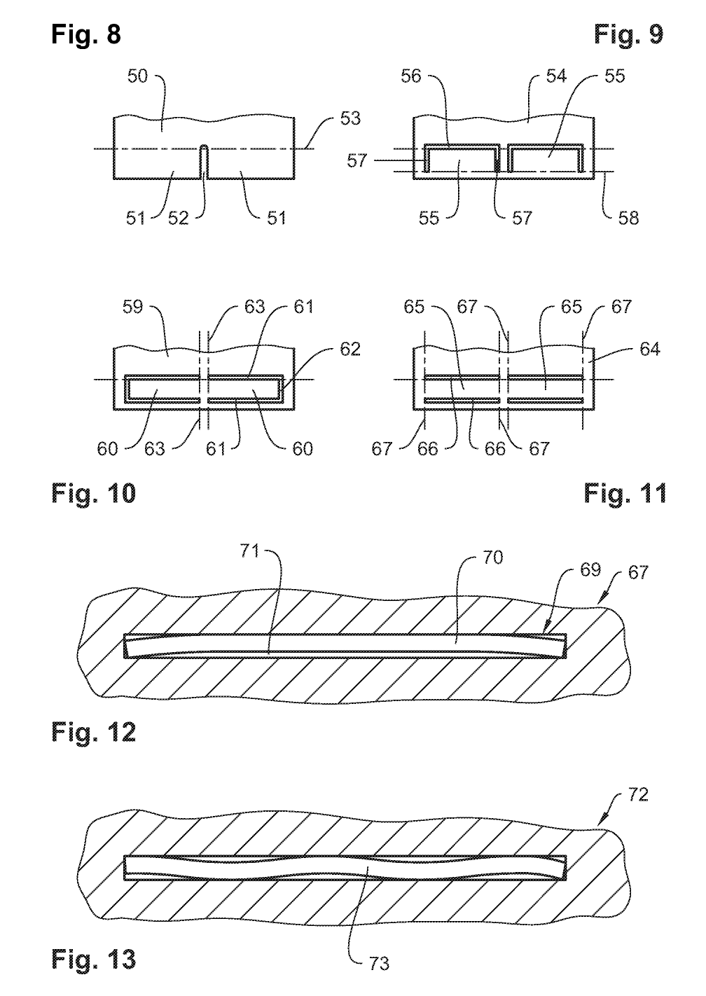

FIG. 8 shows a sipe blade 50 having flaps 51 that are formed by a separating slot 52 in the sipe blade 50. The flaps 51 can each be bent about a horizontal axis 53 in any direction, preferably in opposite directions, once the sipe blade 50 has been inserted into a slot (not illustrated).

FIG. 9 shows a sipe blade 54 having flaps 55 each formed by a horizontal separating slot 56 and two vertical separating slots 57. The flaps 55 can be bent about a horizontal axis 58.

FIG. 10 shows a sipe blade 59 having flaps 60 each formed by horizontal separating slots 61 and one vertical separating slot 62. Each flap 60 can be bent about a vertical axis 63.

FIG. 11 shows a sipe blade 64 having flaps 65 each formed by two parallel horizontal separating slots 66. Each flap 65 can be bent and widened about two vertical axes 67.

FIG. 12 shows a partial section view of a matrix 68 having a slot 69 and a sipe blade 70. The sipe blade 70 is in particular curved so that a gap channel 71 is formed in the slot 69 on both sides of the sipe blade 70.

FIG. 13 shows a matrix 72 which differs from the matrix shown in FIG. 12 in that a sipe blade 73 has a wavelike shape.

1. A matrix (10, 33, 39, 45, 67, 72) for a tire mold for vulcanizing tire blanks, the matrix forming a negative mold (17) of a profiled tread of a tire, the matrix having a mold shell (14) comprising sipe blades (11, 34, 40, 46, 50, 54, 59, 64, 70, 73) arranged thereon, the mold shell forming an inner mold side (15) and the sipe blade forming a web (19) of the negative mold, a plurality of slots (13, 35, 69) being formed in the mold shell, a sipe blade being inserted in a slot and attached to the mold shell,
characterized in that the sipe blade is attached to the mold shell in a form-fitting manner, the slot penetrating a mold wall (21) of the mold shell and extending from the inner mold side to a rear mold side (16, 38, 44, 49) of the mold shell.

2. The matrix according to claim 1,
characterized in that a slot width (b) of the slot (13, 35, 69) and a blade thickness (B) of the sipe blade (11, 34, 40, 46, 50, 54, 59, 64, 70, 73) are dimensioned in such a manner that a gap channel (31, 36, 71) is formed between the sipe blade and the slot.

3. The matrix according to claim 2,
characterized in that the gap channel (31, 36, 71) has a width of 0.01 mm to 0.1 mm, preferably 0.03 mm to 0.04 mm.

4. The matrix according to claim 2,
characterized in that the gap channel (31, 36, 71) is realized as an venting channel for venting the tire mold.

5. The matrix according to claim 1,
characterized in that the sipe blade (11, 34, 40, 46, 50, 54, 59, 64, 70, 73) is in contact with the inner mold side (15) at least in sections.

6. The matrix according to claim 1,
characterized in that a length (L) of the sipe blade (11, 34, 40, 46, 50, 54, 59, 64, 70, 73) is larger in sections than a length (1) of the slot (13, 35, 69).

7. The matrix according to claim 1,
characterized in that the sipe blade (11, 34, 40, 46, 50, 54, 59, 64, 70, 73) is clamped or pre-stressed with zero play between the inner mold side (15) and the rear mold side (16, 38, 44, 49).

8. The matrix according to claim 1,
characterized in that the sipe blade (11, 34, 40, 46, 50, 54, 59, 64, 70, 73) forms a projection (29) that is in contact with the rear mold side (16, 38, 44, 49).

9. The matrix according to claim 8,
characterized in that the projection (29) is formed by bending the sipe blade (11, 34, 40, 46, 50, 54, 59, 64, 70, 73) on the rear mold side (16, 38, 44, 49), the projection protruding out of a slot plane (30).

10. The matrix according to claim 8,
characterized in that the projection (29) is a flap (25, 37, 41, 47, 51, 55, 60, 65) formed by the sipe blade (11, 34, 40, 46, 50, 54, 59, 64, 70, 73), the flap being formed by one or more separating slots (26, 27, 52, 56, 57, 61, 62, 66) in the sipe blade.

11. The matrix according to claim 10,
characterized in that the flap (25, 47, 60, 65) is bent about a vertical axis (28, 63, 67).

12. The matrix according to claim 10,
characterized in that the flap (37, 41, 51, 55) is bent about a horizontal axis (53, 58).

13. The matrix according to claim 1,
characterized in that a receiving groove (22) is formed in the mold shell (14) on the rear mold side (16, 38, 44, 49), the slot (13, 35, 69) ending in said receiving groove.

14. The matrix according to claim 1,
characterized in that the sipe blade (11, 34, 40, 46, 50, 54, 59, 64, 70, 73) is symmetrical.

15. The matrix according to claim 1,
characterized in that at least in sections, the sipe blade (11, 34, 40, 46, 50, 54, 59, 64, 70, 73) has a curved or wavelike cross-section within the slot (13, 35, 69).

16. The matrix according to claim 1,
characterized in that the matrix (10, 33, 39, 45, 67, 72) is formed by a plurality of mold shells (14).

17. A tire mold for vulcanizing tire blanks, the tire mold having a plurality of tire mold segments, the tire mold segment being composed of a segment base and a mold insert,
characterized in that the mold insert has at least one matrix (10, 33, 39, 45, 67, 72) according to claim 1.

18. A method for venting a tire mold according to claim 17,
characterized in that the tire mold is vented via the slot (13, 35, 69).

19. A method for producing a tire mold for vulcanizing tire blanks, a matrix (10, 33, 39, 45, 67, 72) forming a negative mold (17) of a profiled tread of a tire, the matrix having a mold shell (14) on which sipe blades (11, 34, 40, 46, 50, 54, 59, 64, 70, 73) are arranged, the mold shell forming an inner mold side (15) and the sipe blade forming a web (19) of the negative mold, a plurality of slots (13, 35, 69) being formed in the mold shell, a sipe blade being inserted into a slot and attached to the mold shell, characterized in that the sipe blade is attached to the mold shell in a form-fitting manner, the slot penetrating a mold wall (21) of the mold shell and extending from the inner mold side to a rear mold side (16, 38, 44, 49) of the mold shell.

20. The method according to claim 19,
characterized in that the form-fitting connection is formed by deforming the sipe blade (11, 34, 40, 46, 50, 54, 59, 64, 70, 73) on the rear mold side (16, 38, 44, 49).
